(19) United States
(12) Patent Application Publication
(10) Pub. No.: US 2026/0156355 A1
(43) Pub. Date: Jun. 4, 2026

(54) IMAGE PROCESSING APPARATUS, IMAGE PROCESSING METHOD, AND NON-TRANSITORY COMPUTER-READABLE STORAGE MEDIUM

(71) Applicant: CANON KABUSHIKI KAISHA, Tokyo (JP)

(72) Inventor: SHUNSUKE MIYAJIMA, Kanagawa (JP)

(21) Appl. No.: 19/402,139

(22) Filed: Nov. 26, 2025

(30) Foreign Application Priority Data
Dec. 2, 2024 (JP) 2024-209749

(51) Int. Cl. H04N 23/667; G06T 5/70; H04N 23/60

(52) U.S. Cl. CPC H04N 23/667; G06T 5/70; H04N 23/64

(57) ABSTRACT

An image processing apparatus includes an obtaining unit that obtains an image captured by an image capturing apparatus. A determining unit determines whether or not an image capturing condition of the image capturing apparatus is currently being adjusted. A reducing unit reduces noise in the image. A switching unit switches processing applied by the reducing unit for reducing noise in the image such that first reduction processing is applied if the image capturing condition of the image capturing apparatus is not currently being adjusted, and second reduction processing, in which an image input-to-output delay during noise reduction processing is shorter than in the first reduction processing, is applied if the image capturing condition of the image capturing apparatus is currently being adjusted.

### BACKGROUND

### Field of the Technology

The present disclosure relates to an image processing apparatus, an image processing method, and a non-transitory computer-readable storage medium.

### Description of the Related Art

Conventionally, there is known a technique of, under low lighting, amplifying the brightness of an image by applying a gain to the image. However, while the application of gain amplifies brightness, it may also result in the addition of noise. The addition of noise to an image reduces subject visibility. In view of this, there is known a technique of restoring images using an image restoration function such as a noise reduction (hereinafter “NR”) function.

Typically, the higher the image restoration effect of the NR processing used, the higher the processing load and the longer the processing time. In view of this, Japanese Patent Laid-Open No. 2018-182550 discloses a technique in which, in order to perform development processing in real time, high-image-quality development processing involving NR is applied to a region of interest, high-speed development processing not involving NR is applied to regions other than the region of interest, and images obtained from the two types of processing are combined and output. The application of high-image-quality development processing to only the region of interest makes it possible to obtain an image with high image quality while reducing the processing time, and thus makes it possible to check image quality in real time. Furthermore, Japanese Patent Laid-Open No. 2020-39851 discloses a technique in which, in order to facilitate the checking of a change produced in an image by image-quality improvement processing, an original image and a corrected image are displayed such that switching between the images can be performed, or they are displayed next to one

another, or they can be displayed superimposed on each other. The original image can be displayed in real time, and a high-quality image can be displayed as the corrected image.

However, according to the technique disclosed in Japanese Patent Laid-Open No. 2018-182550, NR processing is applied to the region of interest at all times, and NR processing is not applied to regions other than the region of interest. In other words, there is no disclosure of a case in which there is a demand to use NR processing to improve the visibility of regions other than the region of interest or the entire image, which also includes the regions other than the region of interest,. Here, a case will be considered in which a photographer manually adjusts the focal position using an operation member in a system that applies NR processing in real time while capturing a moving image. The focal position is adjusted according to a method of adjusting the focal position by performing a manual operation via an operation member or the like and driving a focus lens while viewing a video. For example, if a large region of interest is set to improve the visibility of the entire image, processing time will increase due to an increase in the NR processing load. This results in an increase in the time gap between the video and the operational response of the operating member, making it difficult to adjust the focal position to the desired position. In particular, the use of processing with a high NR effect, such as NR in which deep learning (hereinafter “DL”) is used, results in a further increase in the NR processing load. Furthermore, according to the technique disclosed in Japanese Patent Laid-Open No. 2020-39851, an original image and a corrected image are displayed such that switching between the images can be performed, or they are displayed next to one another, or they are displayed superimposed on each other, and no consideration is given to a method for reducing processing time while improving visibility.

### SUMMARY

According to one embodiment of the present disclosure, an image processing apparatus is provided that reduces delay in noise reduction processing and also makes it possible to capture images while performing NR processing under settings desired by a user.

According to one embodiment of the present disclosure, an image processing apparatus comprises: an obtaining unit configured to obtain an image captured by an image capturing apparatus; a determining unit configured to determine whether or not an image capturing condition of the image capturing apparatus is currently being adjusted; a reducing unit configured to reduce noise in the image; and a switching unit configured to switch processing applied by the reducing unit for reducing noise in the image such that first reduction processing is applied if the image capturing condition of the image capturing apparatus is not currently being adjusted, and second reduction processing, in which an image input-to-output delay during noise reduction processing is shorter than in the first reduction processing, is applied if the image capturing condition of the image capturing apparatus is currently being adjusted.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a block diagram illustrating an example of a functional configuration of an image processing apparatus according to embodiment 1.

FIG. 2 is a flowchart illustrating an example of NR processing executed by the image processing apparatus.

FIGS. 3A, 3B, 3C, and 3D are diagrams for describing the NR processing by the image processing apparatus.

FIG. 4 is a block diagram illustrating an example of a functional configuration of an image processing apparatus according to embodiment 2.

FIG. 5 is a flowchart illustrating an example of processing for setting a partial area.

FIGS. 6A, 6B, and 6C are diagrams for describing the processing for setting the partial area.

FIG. 7 is a block diagram illustrating an example of a hardware configuration.

### DESCRIPTION OF THE EMBODIMENTS

Hereafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### Embodiment 1

An image processing apparatus 100 according to embodiment 1 executes processing (NR processing) for reducing noise in an input image. Here, for example, a case will be considered in which a user adjusts the focus, which is an image capturing condition, while checking a captured image to which NR processing has been applied. In order to adjust the focus to the main subject, the user performs an operation while checking the image; however, if the NR-processing processing load increases and the processing time increases accordingly, a time difference may occur between real-time situations and the image (video) output as a result of NR processing, making it difficult to adjust the focus appropriately. From such a viewpoint, the image processing apparatus 100 according to the present embodiment obtains an image captured by an image capturing apparatus, and determines whether or not an image capturing condition of the image capturing apparatus is currently being adjusted. Then, the image processing apparatus 100 switches NR processing applied to the obtained image such that first reduction processing is applied if the image capturing condition of the image capturing apparatus is not currently being adjusted and second reduction processing, in which an image input-to-output delay during noise reduction processing is shorter than in the first reduction processing, is applied if the image capturing condition of the image capturing apparatus is currently being adjusted. In the following, processing executed by such an image processing apparatus 100 will be described in detail.

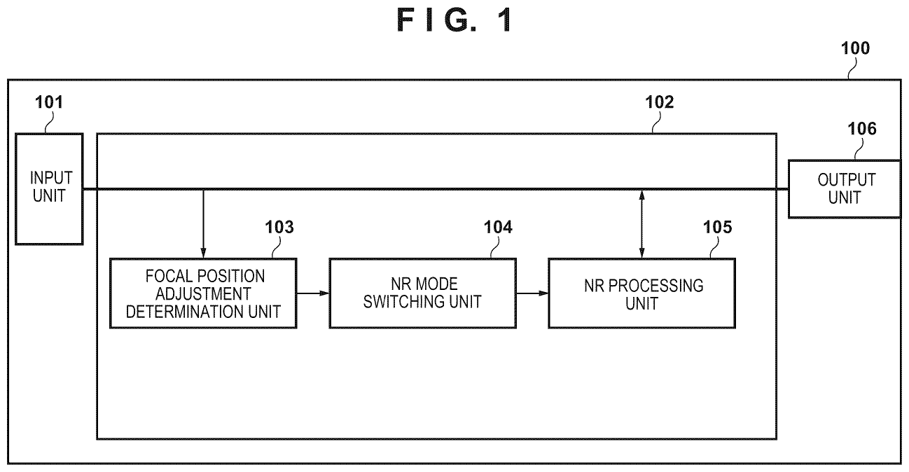

A functional configuration of the image processing apparatus according to the present embodiment will be described with reference to FIG. 1. FIG. 1 is a block diagram illustrating an example of a configuration of the image processing apparatus 100 according to the present embodiment. The image processing apparatus 100 includes an input unit 101, a control unit 102, and an output unit 106. The input unit 101 obtains an image signal (image) that is output from an unillustrated camera. The input unit 101 may obtain the image via a wired connection or by means of wireless communication. In the following, the term “camera”, whenever used independently, refers to an image capturing apparatus that transmits the processing-target image to the image processing apparatus 100 according to the present embodiment. Note that, while description is provided in the present embodiment assuming that the camera and the image processing apparatus 100 are separate apparatuses, the image processing apparatus 100 may be incorporated in the camera. If the image processing apparatus 100 is incorporated in the camera, the input unit 101 can obtain an image captured by an image capturing mechanism of the camera.

The control unit 102 includes an adjustment determination unit 103, a mode switching unit 104, and an NR processing unit 105. The adjustment determination unit 103 determines whether or not an image capturing condition of the camera is currently being adjusted. Here, description is provided in the following assuming that the focal position of the camera is adopted as the image capturing condition. For example, the adjustment determination unit 103 may obtain position information of a focus lens from the camera and determine that the focal position is currently being adjusted if the position of the focus lens is currently changing. Alternatively, for example, the adjustment determination unit 103 may obtain, from the camera, or calculate, based on the image signal obtained by the input unit 101, an image evaluation value, such as the contrast value of the image, that is based on one or more pixel values of the image, and determine that the focal position is currently being adjusted if the image evaluation value is currently changing. Alternatively, for example, the adjustment determination unit 103 may be configured to obtain, from the camera, a signal indicating that a user is currently performing an operation on the camera if such an operation is currently being performed, and may determine that the focal position is currently being adjusted if the signal is currently being obtained. In such a manner, as the determination by the adjustment determination unit 103, any determination method based on information from which it can be determined that the focal position is currently being adjusted in the camera can be adopted, as appropriate.

The mode switching unit 104 switches (the mode of) NR processing applied to the image by the later-described NR processing unit 105 in accordance with whether or not the focal position is currently being adjusted. The mode switching unit 104 according to the present embodiment switches the mode of NR processing to a first mode if the focal position is not currently being adjusted and switches the mode of NR processing to a second mode if the focal position is currently being adjusted. Here, the second mode is a mode in which an input-to-output delay during NR processing is shorter than in the first mode.

Here, description will be provided assuming that the input-to-output delay during NR processing is the time from when the input unit 101 obtains an image signal to when the later-described output unit 106 outputs, to an external apparatus, an image to which NR processing has been applied. In the following, the term “delay”, whenever used independently, refers to such a time from when the input unit 101 obtains an image signal to when the output unit 106 outputs, to an external apparatus, an image to which NR processing has been applied. However, the delay herein may be defined in any way as long as the delay is a time that can be used to evaluate delay in image output caused by NR processing. For example, in an image processing apparatus 100 provided with a function for displaying an image by means of an unillustrated display, the delay may be the time from when the control unit 102 starts applying NR processing to an image to when an image NR processing of which has been completed is displayed on the display of the image processing apparatus 100. The application of NR processing using the second mode with shorter delay reduces the time gap between the video and the feel of operating an operation member experienced by the user, and facilitates the adjustment of the focal position to the desired position. The mode switching unit 104 may adopt, as the second mode, a mode in which NR processing producing a delay within several hundreds of milliseconds (e.g., 300 milliseconds) is applied.

Furthermore, the first mode according to the present embodiment is a mode in which NR processing (normal NR processing) desired by the user of the image processing apparatus 100 is applied. The settings of NR processing in the first mode may be determined based on user input or based on the image signal being currently captured; alternatively, initial settings thereof may be applied.

As mentioned above, the second mode is a mode in which the delay is shorter than in the first mode. As long as the delay is shorter than that in the first mode, the second mode may be a mode in which NR processing of any kind is applied. For example, the second mode may be a mode in which NR processing with lower processing load than that in the first mode is applied, or may be a mode in which NR processing is applied to a partial area that is smaller than the processing-target area in NR processing in the first mode. Alternatively, the second mode may be a mode in which NR processing is applied using a machine learning model that is different from a machine learning model used in NR processing by the first mode, or may be a mode in which the number of image signals used as input when one instance of NR processing is executed is less than that in the first mode. For example, a configuration can be adopted such that the input in one instance of NR processing is a first number of frames (e.g., five frames) that are consecutive in time series in the first mode, and is a second number of frames (e.g., three frames) less than the first number of frames in the second mode.

In the following, the second mode is a mode in which NR processing is applied to a partial area that is smaller than the processing-target area in NR processing in the first mode. Here, the partial area to which NR processing is applied in the second mode is not particularly limited, as long as the partial area is an area that is set within the image and that is smaller than the area to which NR processing is applied in the first mode. For example, a configuration may be adopted such that the processing area of NR processing in the first mode is the entire image, and the processing area of NR processing in the second mode is a partial area within the entire image. Here, the partial area to which NR processing is applied in the second mode is a partial area including a subject in the image.

Alternatively, for example, a configuration may be adopted such that the partial area to which NR processing is applied in the second mode is a predetermined area centered on the central point of the image. As this predetermined area, a rectangular area which has half the width and height of the entire image and centered on the central point of the image can be adopted. Furthermore, any predetermined area, such as the bottom half of the entire image, for example, may be set as such a partial area. Furthermore, such a partial area may be set based on input by the user operating the camera being used to capture the image. Furthermore, for example, a bounding box surrounding a predetermined subject detected by known image recognition processing, for example, may be used as a partial area including a subject. An example in which subject detection is performed will be described later with reference to embodiment 2.

The NR processing unit 105 executes NR processing for reducing noise in the image. Detailed description of NR processing itself is omitted herein because conventional processing for reducing noise in an image can be used. The NR processing unit 105 according to the present embodiment reduces noise in the image by NR processing in the mode switched to by the mode switching unit 104. The output unit 106 outputs, to the outside of the image processing apparatus 100, the image to which NR processing has been applied by the NR processing unit 105.

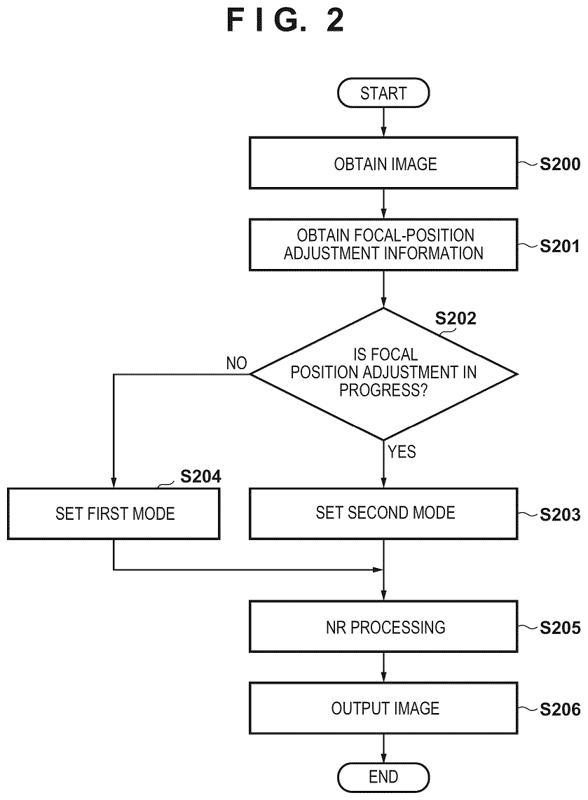

Next, NR processing executed by the image processing apparatus 100 according to present embodiment will be described with reference to FIG. 2. FIG. 2 is a flowchart illustrating an example of NR processing applied by the image processing apparatus 100. For example, the processing illustrated in FIG. 2 is started if an operation for enabling NR processing is input by the user, and is thereafter executed at regular intervals.

In step S200, the input unit 101 obtains an image from the camera.

In step S201, the control unit 102 obtains focal-position adjustment information. The focal-position adjustment information is the position information of the focus lens, an image evaluation value of the image signal, or the like mentioned above.

In step S202, based on the focal-position adjustment information obtained in step S201, the adjustment determination unit 103 determines whether or not the focal position is currently being adjusted. Processing advances to step S203 if the focal position is currently being adjusted, and advances to step S204 if the focal position is not currently being adjusted.

In step S203, the mode switching unit 104 sets the second mode as the mode of NR processing to be applied by the NR processing unit 105, and advances processing to step S205. In step S204, the mode switching unit 104 sets the first mode as the mode of NR processing to be applied by the NR processing unit 105, and advances processing to step S205.

In step S205, the NR processing unit 105 applies NR processing based on the mode set in step S203 or S204. In step S206, the output unit 106 outputs, to the outside of the image processing apparatus 100, the image to which NR processing has been applied in step S205, and ends the processing in FIG. 2.

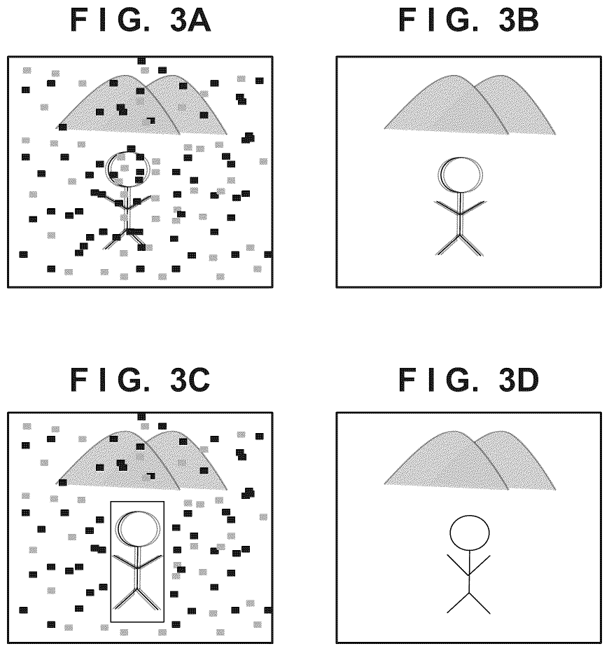

Next, an example of an image to which NR processing by the image processing apparatus 100 according to the present embodiment has been applied will be described with reference to FIGS. 3A to 3D. FIG. 3A illustrates an example of an image before NR processing is applied. In the image illustrated in FIG. 3A, the main subject is covered by a large amount of noise, and visibility is thus low. Due to this, while the main subject is present near the image center in the image illustrated in FIG. 3A, the subject is out of focus, resulting in blur.

FIG. 3B illustrates an example of an image obtained by applying NR processing in the first mode to the image in the state in FIG. 3A. Noise has been reduced in the image illustrated in FIG. 3B due to NR processing in the first mode having been applied to the entire image. However, the focal position has not been adjusted to the main subject in the state illustrated in FIG. 3B.

FIG. 3C is a diagram for describing an input image when the user starts to operate an operation member in a state in which the image illustrated in FIG. 3B is being output, and NR processing applied to the input image. In FIG. 3C, the focal position of the camera is currently being adjusted due to an operation by the user being performed, and thus it is also determined by the adjustment determination unit 103 that the focal position is currently being adjusted. Due to this, the second mode is set as the mode of NR processing, and NR processing is applied only to a partial area including the main subject at the image center in the image illustrated in FIG. 3C. Processing load is reduced and delay is reduced to a further extent by applying NR processing only to a partial area rather than to the entire image; thus, the time gap between the video and the feel of operating the operation member experienced by the user is reduced, and the adjustment of the focal position to the position desired by the user is facilitated.

FIG. 3D illustrates an example of an image generated by NR processing applied in a state in which the operation by the user has ended (the focal position is no longer being adjusted) from the state described with reference to FIG. 3C. In the image illustrated in FIG. 3D, the main subject is in focus because a focal position suitable for the area near the main subject has been set by the low-processing-load NR processing applied to only the partial area, which has been described with reference to FIG. 3C. Because the focal position is not currently being adjusted in the state illustrated in FIG. 3D, NR processing in the first mode is applied to the entirety of such an image in which the main subject is in focus, and thus the visibility of the entire image has improved.

According to such a configuration, it becomes possible to determine whether or not the focal position is currently being adjusted, and, in accordance with the result of such a determination, switch NR processing applied to an image between the first mode and the second mode, in which the delay is shorter than in the first mode. Thus, the delay can be reduced while improving the visibility of the main subject. Furthermore, by switching the NR processing mode back to the first mode after the focal position has been adjusted, it becomes possible to capture an image while executing normal NR processing (NR processing under settings desired by the user, in particular). Accordingly, the focal position can be adjusted manually to the desired subject while using an image restoration function.

In the present embodiment, description has been provided assuming that the determination of whether or not the focal position is currently being adjusted is performed based on a change in an image evaluation value or position information of the focus lens. However, the determination processing by the adjustment determination unit 103 is not limited to such a method in particular as long as it can be determined whether or not the focal position is currently being adjusted. For example, it may be determined that the focal position is currently being adjusted if an autofocus (hereinafter “AF”) operation is currently being performed in the camera (e.g., if an AF start instruction has been provided) or if a command for driving the focus lens is currently being transmitted to the camera (from an external apparatus such as a PC). Note that, in such cases, the AF start instruction, the command for driving the focus lens, or the like is obtained (received) in step S201 in FIG. 2.

Description has provided in the present embodiment assuming that, in the first mode, NR processing is applied in a state in which the entire image is the processing target; however, the processing target in the first mode may also be a partial area within the entire image. In such a case as well, the area to which NR processing is applied in the second mode is set so as to be smaller than the area to which NR processing is applied in the first mode.

Furthermore, description has been provided in the present embodiment assuming that the switching between the first mode and the second mode is executed based on whether or not the focal position is currently being adjusted. However, the use of a condition based on the focal position as the image capturing condition as described above is one example, and, for example, a condition based on the angle of view, zoom, aperture, or the like may be adopted as the image capturing condition, in which case whether or not a control command relating to the angle of view, zoom, aperture, or the like is currently being executed may be used. Furthermore, a configuration may be adopted such that a setting can be made (e.g., based on user input) as to whether or not to execute such switching between modes of NR processing in accordance with such an image capturing condition.

Furthermore, for example, the image processing apparatus 100 may be configured to notify the user whether the current mode for performing NR processing is the first mode or the second mode. For example, the image processing apparatus 100 may display, separately from the image, information (information indicating the current mode) indicating whether NR processing in the first mode or NR processing in the second mode is being performed (on, e.g., an unillustrated display unit), and may display the information indicating the current mode so as to be overlaid on the image.

### Embodiment 2

In embodiment 1, description has been provided of an example in which, in the second mode, NR processing is applied in a state in which the processing area is a partial area that is smaller than the processing area in an image in the first mode. In this case, the partial area can also be set such that, if it is expected that a subject will be present in a specific area (e.g., the image center), the partial area is set to include such a specific area; however, it is not necessarily the case that a subject is present in such an area at all times. From such a viewpoint, an image processing apparatus 100 according to the present embodiment detects a subject in an image, and sets, as the partial area in the image to which NR processing is to be applied in the second mode, a partial area such as that in which such a subject detection area is included.

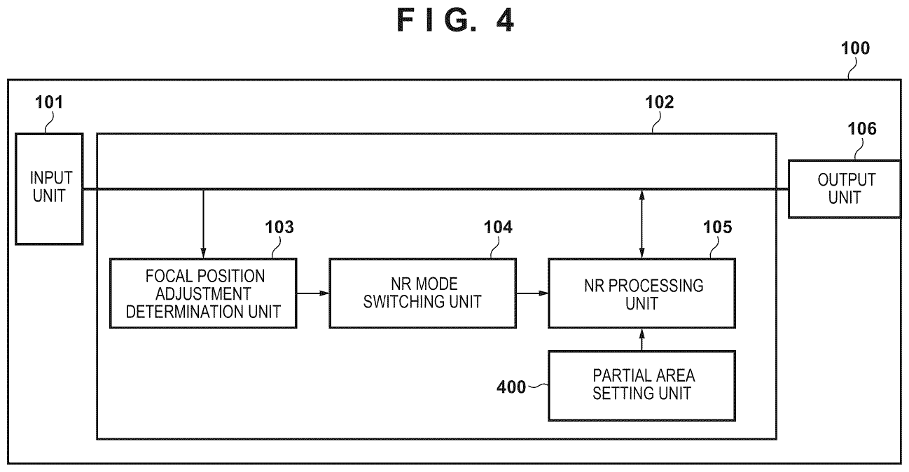

FIG. 4 is a block diagram illustrating an example of a functional configuration of the image processing apparatus 100 according to the present embodiment. Because, with the exception that a partial area setting unit 400 is included, the image processing apparatus 100 according to the present embodiment has the same configuration as that in embodiment 1 and is capable of executing the same processing as that in embodiment 1, redundant description is omitted.

The partial area setting unit 400 sets an image partial area to which NR processing is to be applied in the second mode. The partial area setting unit 400 according to the present embodiment detects a predetermined subject in an image, and sets an area including the subject as the above-described partial area. Note that, while it is assumed here that the image processing apparatus 100 detects a subject, there is no limitation to such a configuration in particular as long as information regarding an area in which a subject has been detected can be obtained. For example, a configuration may be adopted such that the camera, which is separate from the image processing apparatus 100, detects a subject from a captured image, and transmits information regarding the detection to the image processing apparatus 100 together with the image. Alternatively, for example, the partial area setting unit 400 may set the partial area based on an AF frame in the camera, which is an AF detection area, or an AE frame in the camera, which is a detection area for automatic exposure correction (hereinafter “AE”). A configuration may be adopted such that, if there are a plurality of AF frames, the area in which the subject having the highest AF evaluation value is present is set as the partial area. Furthermore, a configuration may be adopted such that, if the user adjusts the focal position and the focal position consequently moves past a focal position at which a subject present in a partial area corresponding to an AF frame that has been selected one previously or earlier is in focus, an AF frame in which the subject having the next highest AF evaluation value after such a partial area is present is set as the partial area. Alternatively, a configuration may be adopted such that, if there are a plurality of AE frames, the area including, within the frame, the subject having an exposure value closest to the appropriate exposure is set as the partial area. In this case, the image processing apparatus 100 can set the appropriate exposure value (based on, e.g., user input).

Alternatively, the partial area setting unit 400 may set the partial area based on user input. The method for setting the area based on user input is not particularly limited; for example, a configuration may be adopted such that the partial area is designated using coordinate parameters with the upper-left corner of an image as the origin, or such that the partial area is designated by receiving user input on an image displayed on a touch panel.

The NR processing unit 105 according to the present embodiment applies NR processing in the second mode to the partial area set by the partial area setting unit 400.

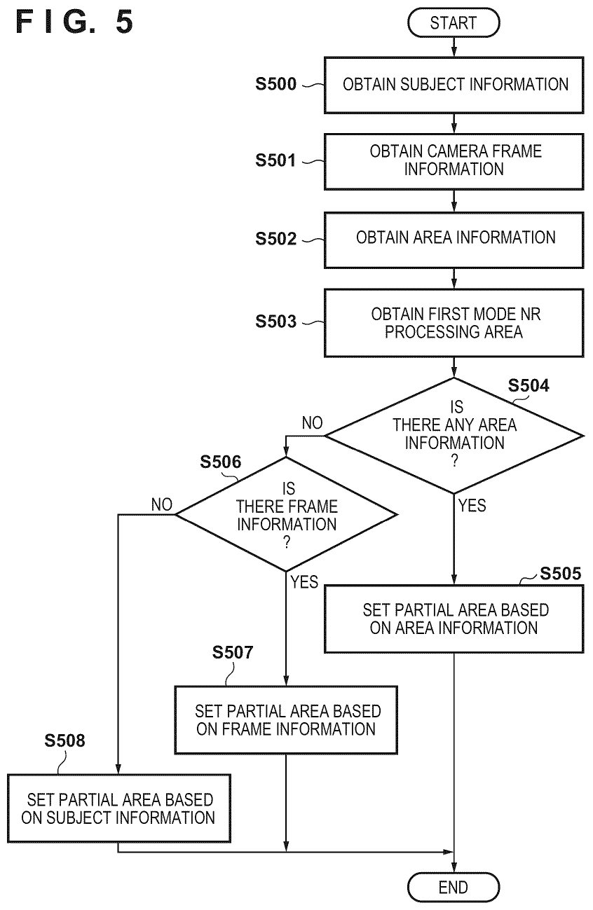

Next, processing in which the partial area setting unit 400 sets the partial area will be described with reference to FIG. 5. FIG. 5 is a flowchart illustrating an example of the processing in which the partial area setting unit 400 sets the partial area. A configuration may be made such that the processing illustrated in FIG. 5 is executed immediately after step S200 in FIG. 2 for example, or such that the processing is executed independently from the processing illustrated in FIG. 2.

In step S500, the control unit 102 obtains subject information. The subject information according to the present embodiment is information including an area (detection area) indicating a subject detected in the image obtained by the input unit 101. As mentioned above, a configuration may be adopted such that the image processing apparatus 100 detects a detection area from the image, or such that the input unit 101 obtains a detection area generated by the camera. For example, the detection area is an area enclosing an entire subject. If there are a plurality of detection areas, the area closest to the image center is selected as the processing-target detection area. Alternatively, for example, a configuration may be adopted such that, if there are a plurality of detection areas, the detection area that is present within the area that is the processing area of NR processing in the first mode is selected as the processing-target detection area.

In step S501, the input unit 101 obtains an AF frame or AE frame set in the camera. Here, for example, the input unit 101 can obtain the AF frame or AE frame via communication with the camera. Here, if both an AF frame and an AE frame are obtained, one of the two frames (the AF frame here) is selected. If neither an AF frame nor an AE frame is set in the camera, or if no AF frame or AE frame can be obtained due to communication with the camera being disabled, information to the effect that information regarding the frames could not be obtained is stored (as, e.g., flag information).

In step S502, the control unit 102 obtains, as a partial area candidate, an area based on user input (area set as desired by the user). If an area based on user input has not been set in step S502, information to the effect that such an area could not be obtained is stored (as, e.g., flag information).

In step S503, the control unit 102 sets the image processing area for NR processing in the first mode. Here, it is assumed that the control unit 102 receives user input and sets the partial area designated by the user as the processing area for NR processing in the first mode; however, a configuration may be adopted such that the entire image is set as the processing area, for example.

In steps S504 to S508, the partial area setting unit 400 sets the partial area that will be the processing area in NR processing in the second mode. In step S504, the partial area setting unit 400 determines whether or not an area has been obtained in step S502. Processing advances to step S505 if an area has been obtained, and otherwise advances to step S506. In step S505, the partial area setting unit 400 sets the partial area that will be the processing area in NR processing in the second mode based on the area based on user input obtained in step S502 and the processing area for NR processing in the first mode obtained in step S503, and ends the processing in FIG. 5. The setting method in step S504 will be described in detail later.

In step S506, the partial area setting unit 400 determines whether or not an AF frame or AE frame has been obtained in step S501. Processing advances to step S507 if an AF frame or AE frame has been obtained, and otherwise advances to step S508. In step S507, the partial area setting unit 400 sets the partial area that will be the processing area in NR processing in the second mode based on the AF frame or AE frame obtained in step S501 and the processing area for NR processing in the first mode obtained in step S503, and ends the processing in FIG. 5. The setting method in step S507 will be described in detail later.

In step S508, the partial area setting unit 400 sets the partial area that will be the processing area in NR processing in the second mode based on the subject information obtained in step S500 and the processing area for NR processing in the first mode obtained in step S503, and ends the processing in FIG. 5. The setting method in step S508 will be described in detail later.

Here, description is provided assuming that the partial area is set based on one of the areas obtained in steps S500 to S502; however, a configuration may be adopted such that only one of steps S500 to S502 is executed, and only the corresponding processing among the processing in steps S504 to S508 is executed. Here, the respective areas are obtained in steps S500 to S502, and, among the areas, the partial area based on user input is preferentially used. This is because it is likely that an area set as desired by the user is an area in which a subject that the user would like to deliberately adjust the focal position to is present. In the example in FIG. 5, if there is no area set as desired by the user, the partial area is then set based on an AF frame or AE frame. This is because it is likely that an AF frame or AE frame set in the camera is an area in which a subject of interest to the user is present.

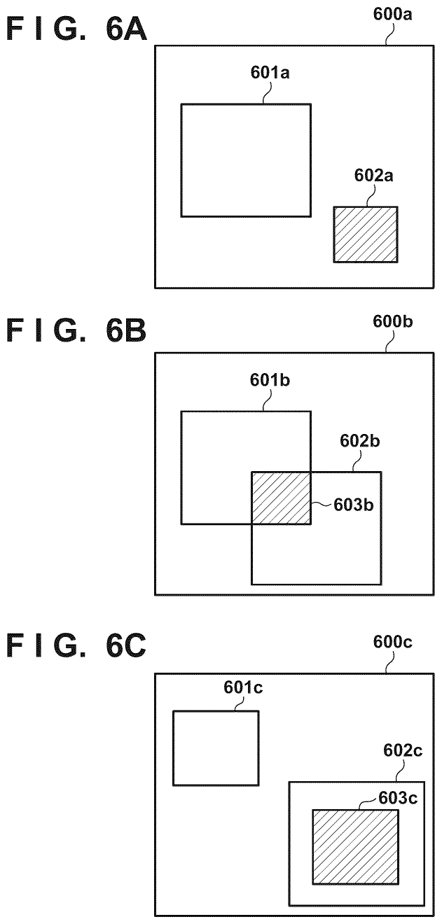

Next, the partial area setting processing executed in steps S505, S507, and S508 will be described with reference to FIGS. 6A to 6C. Here, description will be provided assuming that each of a detection area 602a, a detection area 602b, and a detection area 602c illustrated in FIGS. 6A to 6C is a detection area obtained in step S500; however, processing can be executed similarly even if the detection area is an AF frame or AE frame obtained in step S501 or an area based on user input obtained in step S502, and description in regard to such cases is thus omitted.

In FIG. 6A, examples of a partial area 601a and a detection area 602a that are included in an image 600a are illustrated; the partial area 601a has been obtained in step S503 and will be the processing area in NR processing in the first mode, and the detection area 602a is included in the subject information obtained in step S500. Alternatively, the detection area 602a is an AF frame or AE frame obtained in step S501, or an area set as desired by the user obtained in step S502. In regard to the method of selection, selection of each area is performed in accordance with the flowchart in FIG. 5 as described above. Here, the detection area 602a is an area smaller than the partial area 601a, and it can be expected that the processing load when NR processing is applied to the detection area 602a will be lower than that when NR processing is applied to the partial area 601a. Accordingly, in this case, the partial area setting unit 400 sets the detection area 602a as the partial area that will be the processing area in NR processing in the second mode.

Next, FIG. 6B will be described. In FIG. 6B, examples of a partial area 601b and a detection area 602b that are included in an image 600b are illustrated; the partial area 601b has been obtained in step S503 and will be the processing area in NR processing in the first mode, and the detection area 602b is included in the subject information obtained in step S500. In the case illustrated in FIG. 6B, the detection area 602b is equal to or larger than the partial area 601b in size, and the areas have an overlapping partial area 603b. In this case, for example, the partial area setting unit 400 can set the partial area 603b as the partial area that will be the processing area in NR processing in the second mode. Alternatively, for example, the partial area setting unit 400 may be configured to set an area that includes the partial area 603b and that is smaller than the partial area 601b as the partial area that will be the processing area in NR processing in the second mode. It is conceivable that an area of interest of the user will be set as the area to which NR processing is to be applied in the first mode; thus, an operational feel that is more tailored to the user can be provided by including such an area in the partial area that will be the processing area in NR processing in the second mode.

Next, FIG. 6C will be described. In FIG. 6C, examples of a partial area 601c and a detection area 602c that are included in an image 600c are illustrated; the partial area 601c has been obtained in step S503 and will be the processing area in NR processing in the first mode, and the detection area 602c is included in the subject information obtained in step S500. In the case illustrated in FIG. 6C, the detection area 602c is equal to or larger than the partial area 601c in size, and the areas do not have any overlapping areas. In such a case, the partial area setting unit 400 sets a partial area 603c that is included in the detection area 602c and smaller than the partial area 601c as the partial area that will be the processing area in NR processing in the second mode.

According to such a configuration, it becomes possible to, in a state in which the processing-target partial area in the second mode has already been set, determine whether or not the focal position is currently being adjusted, and, in accordance with the result of such a determination, switch NR processing applied to an image between the first mode and the second mode, in which the delay is shorter than in the first mode. Thus, the delay can be reduced while improving the visibility of the main subject. Furthermore, by switching the NR processing mode back to the first mode after the focal position has been adjusted, it becomes possible to capture an image while executing normal NR processing (NR processing under settings desired by the user, in particular). Accordingly, the focal position can be adjusted manually to the desired subject while using an image restoration function.

Note that a configuration may be adopted such that, in a case in which the user sets a desired area as the partial area that will be the processing area in NR processing in the second mode, no area larger than the area that serves as the processing area in NR processing in the first mode can be set. Furthermore, a configuration may be adopted such that, in a case in which a subject detection area is set as the partial area that will be the processing area in NR processing in the second mode, an area (rectangular area in particular) that includes a subject and that is smallest in area is set as such a subject detection area.

### Embodiment 3

In the above-described embodiments, each of the processing units illustrated in FIG. 1, etc., for example, may be realized by dedicated hardware. Alternatively, some or all of the processing units included in the image processing apparatus 100 may be realized by a computer. In the present embodiments, at least some of the processing according to each of the above-described embodiments is executed by a computer.

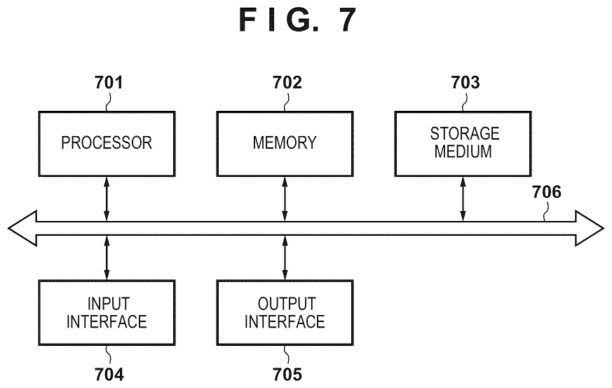

FIG. 7 is a diagram illustrating a basic configuration of the computer. In FIG. 7, a processor 701 is a CPU, for example, and controls the operation of the entire computer. A memory 702 is a RAM, for example, and temporarily stores programs, data, etc. A computer-readable storage medium 703 is a hard disk, a CD-ROM, or the like, for example, and stores programs, data, etc., over a long period of time. In the present embodiment, one or more programs for realizing the functions of the units that are stored in the storage medium 703 are read out to the memory 702. Furthermore, the functions of the units are realized by the processor 701 operating in accordance with the programs on the memory 702.

In FIG. 7, an input interface 704 is an interface for obtaining information from external apparatuses. Furthermore, an output interface 705 is an interface for outputting information to external apparatuses. A bus 706 connects the above-described units, and allows the units to exchange data with one another.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-209749, filed Dec. 2, 2024, which is hereby incorporated by reference herein in its entirety.

What is claimed is:

1. An image processing apparatus comprising:
an obtaining unit configured to obtain an image captured by an image capturing apparatus;
a determining unit configured to determine whether or not an image capturing condition of the image capturing apparatus is currently being adjusted;
a reducing unit configured to reduce noise in the image; and
a switching unit configured to switch processing applied by the reducing unit for reducing noise in the image such that first reduction processing is applied if the image capturing condition of the image capturing apparatus is not currently being adjusted, and second reduction processing, in which an image input-to-output delay during noise reduction processing is shorter than in the first reduction processing, is applied if the image capturing condition of the image capturing apparatus is currently being adjusted.

2. The image processing apparatus according to claim 1, wherein the image capturing condition is a focal position of the image capturing apparatus.

3. The image processing apparatus according to claim 2, wherein the determining unit determines whether or not the focal position of the image capturing apparatus is currently being adjusted, based on a position of a focus lens of the image capturing apparatus or an image evaluation value based on one or more pixel values of the image.

4. The image processing apparatus according to claim 2, wherein the determining unit determines that the focal position of the image capturing apparatus is currently being adjusted if the image capturing apparatus is currently receiving a command to drive a focus lens.

5. The image processing apparatus according to claim 1, wherein the image capturing condition is a condition based on zoom of the image capturing apparatus.

6. The image processing apparatus according to claim 1, wherein the image capturing condition is a condition based on an aperture of the image capturing apparatus.

7. The image processing apparatus according to claim 1, wherein the second reduction processing is processing in which noise reduction processing is applied to a processing area that is an area of the image that is smaller than an area that is a processing area in the first reduction processing.

8. The image processing apparatus according to claim 7, wherein the area that is the processing area in the first reduction processing is an entirety of the image, and the area that is the processing area in the second reduction processing is a partial area of the image.

9. The image processing apparatus according to claim 8 further comprising a first setting unit configured to set the partial area.

10. The image processing apparatus according to claim 9, wherein the first setting unit sets the partial area based on user input.

11. The image processing apparatus according to claim 9, wherein the first setting unit sets the partial area based on an AF frame of the image capturing apparatus in the image, the AF frame being a frame for autofocus.

12. The image processing apparatus according to claim 11, wherein, if there are a plurality of AF frames, the first setting unit sets, as the partial area, an AF frame in which a subject having a highest AF evaluation value is present.

13. The image processing apparatus according to claim 9, wherein the first setting unit sets the partial area based on an AE frame of the image capturing apparatus in the image, the AE frame being a detection area for automatic exposure correction.

14. The image processing apparatus according to claim 13 further comprising a second setting unit configured to set an appropriate exposure,
wherein, if there are a plurality of AE frame, the first setting unit sets, as the partial area, an AE frame including a subject having an exposure value closest to the appropriate exposure.

15. The image processing apparatus according to claim 1, wherein the second reduction processing is processing in which noise in the image is reduced using a machine learning model that is different from a machine learning model used in the first reduction processing.

16. The image processing apparatus according to claim 1, wherein the determining unit determines whether or not the image capturing condition is currently being adjusted, based on whether or not a user is currently operating the image capturing apparatus.

17. The image processing apparatus according to claim 1 further comprising a display unit configured to display information indicating which of the first reduction processing and the second reduction processing is currently being applied by the reducing unit as the processing for reducing noise in the image.

18. The image processing apparatus according to claim 1 further comprising a third setting unit configured to set whether or not the switching unit is to switch the processing for reducing noise in the image.

19. An image processing method comprising:
obtaining an image captured by an image capturing apparatus;
determining whether or not an image capturing condition of the image capturing apparatus is currently being adjusted;
reducing noise in the image; and
switching processing applied by the reducing unit for reducing noise in the image such that first reduction processing is applied if the image capturing condition of the image capturing apparatus is not currently being adjusted, and second reduction processing, in which an image input-to-output delay during noise reduction processing is shorter than in the first reduction processing, is applied if the image capturing condition of the image capturing apparatus is currently being adjusted.

20. A non-transitory computer-readable storage medium configured to store a computer program comprising instructions for executing following processes:
obtaining an image captured by an image capturing apparatus;
determining whether or not an image capturing condition of the image capturing apparatus is currently being adjusted;
reducing noise in the image; and
switching processing applied by the reducing unit for reducing noise in the image such that first reduction processing is applied if the image capturing condition of the image capturing apparatus is not currently being adjusted, and second reduction processing, in which an image input-to-output delay during noise reduction processing is shorter than in the first reduction processing, is applied if the image capturing condition of the image capturing apparatus is currently being adjusted.
